(19) United States
(12) Patent Application Publication
(10) Pub. No.: US 2008/0087826 A1
(43) Pub. Date: Apr. 17, 2008

(54) OPTICAL TRAIN AND METHOD FOR TIRF SINGLE MOLECULE DETECTION AND ANALYSIS

(75) Inventors: Timothy D. Harris, Toms River, NJ (US); Philip R. Buzby, Brockton, MA (US); Mirna Jarosz, Boston, MA (US); Jaime Gill, Marshfield Hills, MA (US); Howard Weiss, Newton, MA (US); Stanley N. Lapidus, Bedford, NH (US)

Correspondence Address: COOLEY GODWARD KRONISH LLP;ATTN: Patent Group, Suite 1100, 777 - 6th Street, NW, WASHINGTON, DC, 20001, US

(73) Assignee: Helicos BioSciences Corporation, Cambridge, MA (US)

(21) Appl. No.: 11/928,715

(22) Filed: Oct. 30, 2007

Related U.S. Application Data
(63) Continuation of application No. 11/849,088, filed on Aug. 31, 2007.
Application No. 11/849,088 is a continuation of application No. 11/234,420, filed on Sep. 23, 2005, now abandoned.
Application No. 11/234,420 is a continuation-in-part of application No. 10/990,167, filed on Nov. 16, 2004.

(51) Int. Cl. G01J 5/02; G01T 1/16

(52) U.S. Cl. 250/353; 250/363.01

(57) ABSTRACT

In one aspect the invention relates to an apparatus for analyzing the presence of a single molecule using total internal reflection. In one embodiment an apparatus for single molecule analysis includes a support having a sample located thereon; two sources of light at distinct wavelengths, a collimator for directing the light onto the sample through a total internal reflection objective; a receiver for receiving a fluorescent emission produced by a single molecule in the sample in response to the light; and a detector for detecting each of the wavelengths in the fluorescent emission. In another embodiment the apparatus further comprises a focusing laser for maintaining focus of the objective on the sample.

This application is a continuation of U.S. patent application Ser. No. 11/234,420, filed on Sep. 23, 2005, which claims priority to U.S. patent application Ser. No. 10/990,167, filed on Nov. 16, 2004, which are hereby incorporated by reference in their entirety.

### FIELD OF THE INVENTION

The invention relates generally to the optical detection and analysis of single molecules and more specifically to the optical detection of single molecules using total internal reflection.

### BACKGROUND OF THE INVENTION

Single molecule analysis permits a researcher to analyze the sequence of bases in a nucleic acid strand by building a complementary strand to the nucleic acid of interest one base at a time and determining which base has been incorporated. By performing this operation on hundreds of sample nucleic acids simultaneously one can sequence a large genome is a relatively short period.

To perform this form of sequencing many techniques have been used, ranging from chromatographic columns to radionuclide detection. Most of these methods suffer from a difficulty in detecting the addition of a single base repeatedly.

The present invention provides a mechanism to not only detect and record the addition of bases to multiple samples of DNA at a time but also to do so repeatedly and accurately.

### SUMMARY OF THE INVENTION

In one aspect the invention relates to an apparatus for analyzing the presence of a single molecule using total internal reflection fluorescence (TIRF). In one embodiment an apparatus for single molecule analysis includes a support having a sample located thereon; at least two lasers that produce light at distinct wavelengths, a collimator for directing the light onto the sample through a total internal reflection (TIR) objective; a receiver for receiving a fluorescent emission produced by a single molecule in the sample in response to the light; and a detector for detecting each of the wavelengths in the fluorescent emission. In another embodiment the apparatus further comprises a focusing laser for maintaining focus of the objective on the sample.

In one embodiment the collimator includes a band-pass filter, a diverging lens in optical communication with the band-pass filter, a collimating lens in optical communication with the diverging lens, a field stop in optical communication with the collimating lens, and a converging lens in optical communication with the field stop. In another embodiment the receiver includes a tube lens and a band-pass filter in optical communication with the tube lens.

In yet another embodiment the support is a stage that is associated with a flow cell. In another embodiment the cameras are in communication with a computer for storage and analysis of images produced by fluorescent emission.

In another embodiment the apparatus for analysis of single molecules includes a first laser; a band-pass filter in optical communication with said the laser; at least one first lens in optical communication with the band-pass filter; a second laser; a second band-pass filter in optical communication with the second laser; at least one second lens in optical communication with the second band-pass filter; and a dichroic beam combiner in optical communication with the at least one first lens and the at least one second lens. A collimator is in optical communication with the dichroic beam combiner; a field stop in optical communication with the collimator; an illumination dichroic lens for passing light from said first and second lasers to an objective for focusing on a sample and for passing fluorescent emissions from said sample to a detector. A camera dichroic filter is positioned for passing light of a first wavelength to a first camera and light of a second wavelength to a second camera; and a computer in communication with the first and second cameras for analyzing the fluorescent emissions.

In one embodiment the apparatus includes a sample plate having a sample located thereon; one or more sources for providing two wavelengths of light; a collimator for producing a spot of collimated light of a defined size on said sample; a receiver of a fluorescent image produced by the sample by each of said wavelengths of light and reducing non-fluorescent light; and a detector for detecting the fluorescent image produced by the sample by each of said wavelengths of light. In one embodiment the apparatus further includes a device for maintaining focus of the fluorescent image of said sample. In another embodiment the light source for providing two wavelengths of light includes two lasers.

In yet another embodiment the collimator includes a band-pass filter, a diverging lens in optical communication with the band-pass filter; a collimating lens in optical communication with the diverging lens; a field stop in optical communication with the collimating lens, and a converging lens in optical communication with the field stop. In still yet another embodiment the receiver includes a tube lens; and a band-pass in optical communication with the tube lens. In one embodiment the detector includes a camera.

In another aspect the invention relates to a method for analyzing a single molecule comprising the steps of providing a sample; producing light at two distinct wavelengths; directing the light at two distinct wavelengths onto the sample through a total internal reflection objective; receiving fluorescent emissions produced by a single molecule in the sample in response to the light at two distinct wavelengths; and detecting the fluorescent emissions. In yet another aspect, the invention relates to a method for analyzing a single molecule comprising the steps of: providing a sample; producing light at two distinct wavelengths; directing the light at two distinct wavelengths onto the sample through a total internal reflection objective; receiving fluorescent emissions produced by a single molecule in the sample in response to the light at two distinct wavelengths; and detecting the fluorescent emissions.

Systems of the invention are preferably configured to operate with slides, arrays, channels, beads, bubbles, and the like that contain nucleic acid duplex for sequencing. In a preferred embodiment, the stage supports a flow cell that houses a glass or fused silica slide on which duplex is contained. Preferred slides are coated with an epoxide, polyelectrolyte multilayer, or other coating suitable to bind nucleic acids. In a highly-preferred embodiment, as described below, slides are coated with an epoxide and nucleic acids are attached directly via an amine linkage. Either the template, the primer, or both may be attached to the surface. In other embodiments, the epoxide coating is derivatized to aid duplex attachment. For example, epoxide can be derivatized with streptavidin and duplex (primer, template, or both) can bear a biotin terminus that will attach to the streptavidin. Alternatively, other binding pairs, such as antigen/antibody or receptor/ligand pairs, may be used. Ideally, an epoxide surface is passivated in order to reduce background. Passivation can be conducted by exposing the surface to a molecule that attaches to the open epoxide ring. Examples of such molecules include, but are not limited to, amines, phosphates, and detergents.

Systems of the invention are useful in conducting template-dependent sequencing-by-synthesis reactions. Typically, those reactions involve the attachment of duplex to the imaging surface, followed by exposure to a plurality of optically-labeled nucleotide triphosphates in the presence of polymerase. The sequence of the template is determined by the order of labeled nucleotides incorporated into the 3′ end of the primer portion of the duplex. This can be done in real time or can be done in a step-and-repeat mode as described below. For real-time analysis, it is useful to attach different optical labels to each nucleotide to be incorporated and to utilize multiple lasers for stimulation of incorporated nucleotides. Such modifications are within the knowledge of those of ordinary skill in the art.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1 is a perspective schematic diagram of a generalized embodiment of the invention;

FIG. 2 is a perspective schematic diagram of a generalized embodiment of the invention of FIG. 1 including an auto-focus component;

FIG. 2a is a block diagram of an embodiment of the auto-focus portion of FIG. 2; and

FIG. 3 is a perspective schematic diagram of another embodiment of the invention.

### DESCRIPTION OF THE PREFERRED EMBODIMENT

In general overview, there are three main embodiments of the invention. The first is the use of multiple excitatory wavelengths with fluorescent probes in a TIRF system for single molecule detection and analysis; the second is the use of a single wavelength with auto-focus with and without TIRF for single molecule detection and analysis; and the third is the use of multiple wavelengths with fluorescent probes in a TIRF system with auto-focus for single molecule detection and analysis.

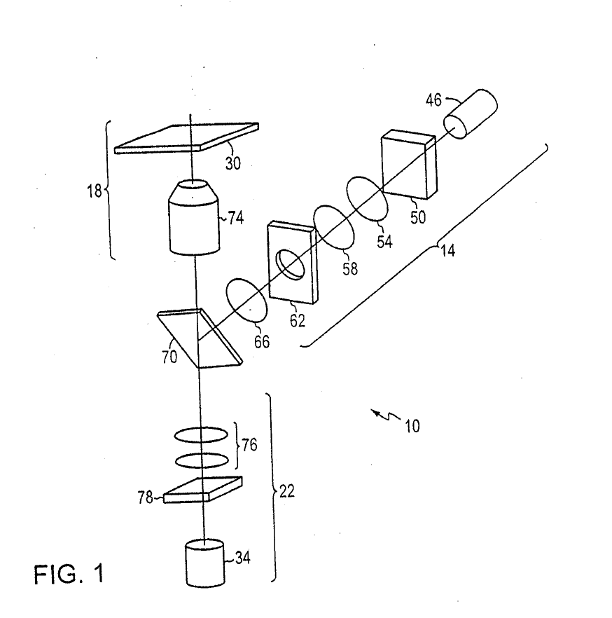

Referring to FIG. 1, a general overview of the device is shown. The optical train 10 in the embodiment shown includes an optical source 14, a sample portion 18, and a signal detection portion 22. Light from the optical source 14 is directed onto the sample plate 30 of the sample portion 18 causing the single molecules of the sample to fluoresce. Fluorescence from the sample plate 30 is filtered and detected by the detector 34 of the detector portion 22. Light of various wavelengths can be sourced and detected by various specific wavelength optical source portions 14 and detector portions 22.

In more detail, in this embodiment, the optical source 14 includes a laser 46 which is either tunable to the various wavelengths of interest or replaceable by other lasers having the various wavelengths of interest. Light from the laser 46 passes through a band-pass filter 50 which passes a band of wavelengths centered on the wavelength of the laser 46. This light then passes through sizing collimator which includes a diverging lens 54 to widen the light beam for sample irradiation; a collimation lens 58 to make the beam paths parallel; a field-stop 62 to reduce the size of the beam; and a converging lens 66 to produce the correct spot size.

The light is then reflected by an illumination dichroic 70, angled at 45° to the incident beam direction, through a TIR oil immersion objective 74 onto the sample plate 30. The sample plate 30 is positioned on a movable X-Y stage. Fluorescence from molecules on the sample plate 30 and other light pass back through the oil immersion objective 74; through the illumination dichroic 70; and through a tube-lens 76. After passing through the tube-lens 74, the light passes through a first band-pass filter 78 to remove wavelengths of the stimulating light from the light source 46 which have passed this far through the optical train before reaching the camera 34, from the fluorescent light generated by the fluorophore in the sample.

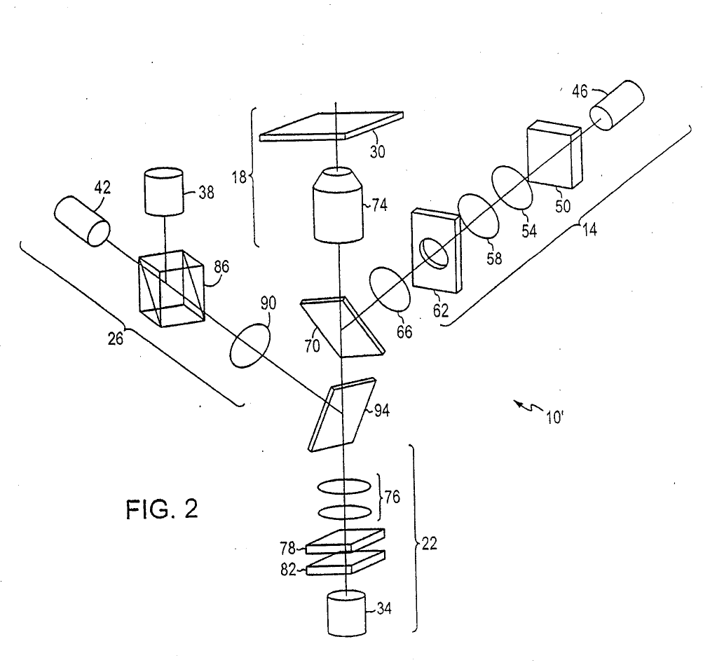

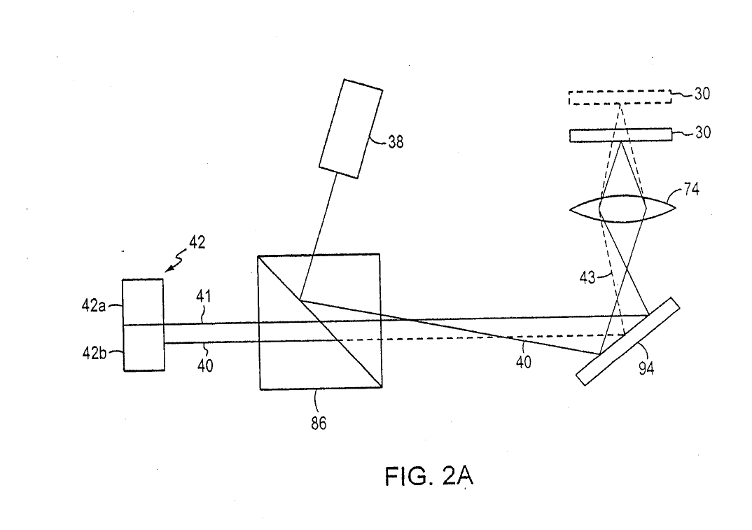

Referring also to FIG. 2, another embodiment of the invention including an auto-focus portion 26 is shown. Focus of the image of the sample's fluorescence is maintained in this embodiment by measuring the light reflected by the sample plate 30 from the light source 38 to the detector 42 of the auto-focus portion 26. In order to maintain the focus of the sample on the sample plate 30 as the plate is moved on its X-Y positioner, light from a source 38, in one embodiment an infra-red source, is passed through and reflected by a 50/50 beam splitter cube 86, through a converging lens 90 to an auto-focus dichroic 94, which has been positioned in and at 45° to the optical path from the illumination dichroic 70. The beam, reflecting from the auto-focus dichroic 94, passes through the illumination dichroic 70 and the TIR oil immersion objective 74 to the sample plate 30.

This light is reflected by the sample plate 30, back through the oil immersion objective 74 and the illumination dichroic 70 to be reflected by the auto-focus dichroic 94. This reflected light passes back through the converging lens 90 and the beam splitter cube 86 to reach auto-focus detector 42.

Referring to FIG. 2a, the auto-focus portion 26 in conjunction with the dichroic 94 and the sample portion 18 is shown. The auto-focus in this embodiment uses a skew beam method of operation. In this embodiment the light source 38 projects a beam onto the beam splitter cube 86 at an off-angle to the diagonal of the cube 86. The reflected beam 40 is reflected by the dichroic 94 and focused on the sample plate 30 by lens 74. The light returned from the sample 30 is focused by lens 74 back on the dichroic 94 which reflects the beam back to the beam splitter cube 86.

The angles are chosen such that when the sample is at the proper focal position from the lens 74, the reflected light from the dichroic 94 passes through the beam splitter cube 86 and hits the auto-focus detector 42. The auto-focus detector 42 includes two adjacent photocell detectors 42a, 42b. When the beam is in focus, the reflected light 41 from the dichroic 94 hits the detectors 42a, 42b equally.

When the sample plate 30 is moved (shown in phantom) the path from the lens 74 to the sample plate 30 changes, causing the return beam 43 (shown in phantom) to impinge upon the dichroic 94 at a different angle and be reflected to the beam splitter cube 86 off axis. As the beam 43 passes through the cube 86, it hits one 42b of the two adjacent photocells 42a, 42b more than the other 42a. This causes the photocells 42a, 42b to have a voltage difference between them. This voltage difference can the be used to control a motor (not shown) attached to the lens 74, to move the lens or the stage so as to bring the sample 30 back into focus again. Once the sample 30 is in focus, the two photocell detectors 42a, 42b are equally illuminated, the voltage difference returns substantially zero and the motor stops moving the lens 74. Thus the optical system converts motion perpendicular to the sample into lateral motion across the detector 42.

In order to prevent light from the auto-focus source 38 from reaching the detector 34, light from the sample, after passing through band-pass filter 78, passes through a notch filter 82 having a notch centered on maximum intensity of the wavelength of the fluorescence of the sample; before reaching the detector 34. This embodiment can be used with either a single wavelength excitatory source or with a multi-wavelength excitatory source as just described, with and without the TIR oil immersion objective 74.

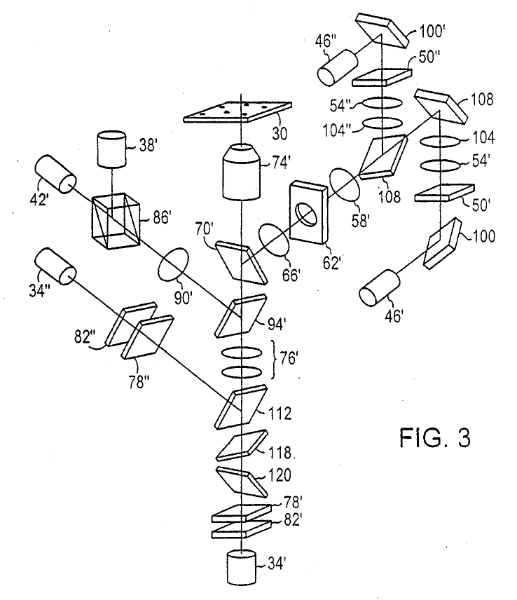

Because multi-wavelength sources of the desired power and multi-wavelength detectors are not readily available at the desirable wavelengths, FIG. 3 shows an embodiment of a system which permits near simultaneous measurements at two different wavelengths with auto-focus using separate light sources. In this embodiment, two lasers 46′, 46″, each set to a different wavelength, 647 nm and 532 nm respectively, produce beams which are reflected by turning mirrors 100 and 100′ through band-pass filters 50′, 50″. In one embodiment the 532 nm laser 46″ is a 2 w laser and the 647 nm laser 46′ is an 800 mw laser. In this embodiment the bandpass filters 50′, 50″ are centered to pass 647 nm and 532 nm, respectively.

The first beam then passes through a diverging lens 54′ and a relay lens 104, before being turned by a turning mirror 108. Similarly the second beam passes through diverging lens 54″ and relay lens 104′ before being made coincident with the first beam in the dichroic beam combiner 108 positioned at 45° to the optical paths of the beams from the two lasers 46′,46″. The two beams then pass through a collimator including: a collimation lens 58′ to make the beam paths parallel; a field-stop 62′ to reduce the size of the beam; and a converging lens 66′ to produce the correct spot size at the sample plate 30′.

The light beams are then reflected by an illumination dichroic 70′ through a Nikon 1.45 numerical aperture TIR oil immersion objective 74′ onto the sample plate 30′. The sample plate 30′ is positioned on a movable X-Y stage. In one embodiment the X-Y sample stage is equipped with a flow cell sample plate to permit reagents to flow and reactions to occur repetitively during the operation of the system.

Fluorescence from molecules on the sample plate 30′ and other light pass back through the TIR oil immersion objective 74′; back through the illumination dichroic 70′; and through a receiver including a tube-lens 76′. After passing through the tube-lens 76′, the light beams are reflected by a detector dichroic 112 through an 650 nm edge filter 116, a compensation plate 120, to remove beam ellipticity, a first 700 nm band-pass filter 78′ and a 785 nm notch filter 82′ before reaching the red light detector 34′. In this embodiment the detector 34 is a CCD camera 34′.

At the same time, a portion of the light from the sample is reflected by the detector dichroic 112, and passes through a 580 nm band-pass filter 78″ and a 785 nm notch filter 82″ before reaching the green light detector 34″. In one embodiment this detector is a CCD camera 34″. The images from the CCD cameras 34′, 34″ are collected and analyzed by a computer (not shown).

In order to maintain the focus of the sample on the sample plate 30′ as the plate is moved on its X-Y positioner, 785 nm IR light from an 5 mw IR source 38′ is reflected by and passed through a 50/50 beam splitter cube 86′, through a converging lens 90′ to an auto-focus dichroic 94′ in and at 45° to the optical path of the illumination dichroic 70′. The IR beam, reflecting from the auto-focus dichroic 94, passes through the illumination dichroic 70′ and the TIR oil immersion objective 74′ to the sample plate 30′. This light is reflected by the sample plate 30′, back through the TIR oil immersion objective 74′, to be reflected by the auto-focus dichroic 94′. This reflected light passes back through the converging lens 90′ and the 50/50 beam splitter cube 34″ to reach auto-focus detector 42′.

The operation of the system depends in part on which configuration is used. However, operation of the system is independent of sample preparation, which may take various forms. Sample DNA to be sequenced is rendered single stranded if necessary, and sheared to produce small fragments, ranging in size between about 20 bp and 100 bp. Fragments are polyadenylated using terminal transferase or another appropriate enzyme. A poly-A tail of about 50 bp is preferred. An amino-terminated ATP is then added, and the fragments are attached to the sample plate 30′ by direct amine attachment to epoxide on the surface. Next a poly-thymidine primer is hybridized to the attached fragments.

If a two laser wavelength configuration is used, a fluorophore, which is excitable by green laser light, is attached to one of the adenines in the the poly-A portion of the template. When irradiated by the green light from the laser, the fluorophore fluoresces and its position is detected by the CCD camera 34″ with the appropriate filters to only permit fluorescence excited by the green light to reach the camera 34″. This fluorescence serves as a way for the location of the fragment on the sample plate 30′ to be determined after each nucleotide base is added to the sample plate 30′ If a single wavelength laser configuration is used, the fluorophore is not attached and the incorporated fluorescent bases (see below) provide the fluorescence to determine the location of the DNA fragment on the sample plate 30′.

Next, single nucleotides are introduced on to the plate 30′, one nucleotide species at a time. Each species carries a fluorophore that will fluoresce when excited by red laser light. After each nucleotide species with the fluorescent label is introduced onto the sample plate 30′ along with the appropriate polymerase mixture and allowed to react, the sample plate is washed to remove any nucleotide which has not be incorporated into the primer. Only a nucleotide that is complementary to the next nucleotide of the template adjacent the 3′ terminus of the primer will be incorporated.

Then the sample plate 30′ is irradiated by red laser light. If the last added nucleotide is incorporated into the chain, the incorporated nucleotide in the chain will fluoresce. If the nucleotide is not incorporated, no fluorescence will be detected. This light is detected by the CCD camera which has the appropriate filters in place to only permit fluorescent light excited by the red laser light to reach the CCD camera 34′.

Next, if the fluorescent nucleotide is incorporated, the fluorophore is cleaved and capped as described in detail below. The next nucleotide species with attached fluorophore is then added and the cycle repeated.

By keeping track of which nucleotide is added to each duplex by noting the incorporated fluorescence, the sequence of nucleotide bases that are complementary to the attached fragment is determined. That sequence data may be combined with the sequence data from other fragments to thereby sequence the entire DNA sample or genome.

### EXAMPLE

The 7249 nucleotide genome of the bacteriophage M13mp18 was sequenced using a single molecule system of the invention. Purified, single-stranded viral M13mp18 genomic DNA was obtained from New England Biolabs. Approximately 25 ug of M13 DNA was digested to an average fragment size of 40 bp with 0.1 U Dnase I (New England Biolabs) for 10 minutes at 37° C. Digested DNA fragment sizes were estimated by running an aliquot of the digestion mixture on a precast denaturing (TBE-Urea) 10% polyacrylamide gel (Novagen) and staining with SYBR Gold (Invitrogen/Molecular Probes). The DNase I-digested genomic DNA was filtered through a YM10 ultrafiltration spin column (Millipore) to remove small digestion products less than about 30 nt. Approximately 20 pmol of the filtered DNase I digest was then polyadenylated with terminal transferase according to known methods (Roychoudhury, R and Wu, R. 1980, Terminal transferase-catalyzed addition of nucleotides to the 3′ termini of DNA. Methods Enzymol. 65(1):43-62.). The average dA tail length was 50+/−5 nucleotides. Terminal transferase was then used to label the fragments with Cy3-dUTP. Fragments were then terminated with dideoxyTTP (also added using terminal transferase). The resulting fragments were again filtered with a YM10 ultrafiltration spin column to remove free nucleotides and stored in ddH2O at −20° C.

Epoxide-coated glass slides were prepared for oligo attachment. Epoxide-functionalized 40 mm diameter #1.5 glass cover slips (slides) were obtained from Erie Scientific (Salem, N.H.). The slides were preconditioned by soaking in 3×SSC for 15 minutes at 37° C. Next, a 500 pM aliquot of 5′ aminated polydT(50) (polythymidine of 50 bp in length with a 5′ terminal amine) was incubated with each slide for 30 minutes at room temperature in a volume of 80 ml. The resulting slides had poly(dT50) primer attached by direct amine linkage to the epoxide. The slides were then treated with phosphate (1M) for 4 hours at room temperature in order to passivate the surface. Slides were then stored in polymerase rinse buffer (20 mM Tris, 100 mM NaCl, 0.001% Triton X-100, pH 8.0) until they were used for sequencing.

For sequencing, the slides were placed in a modified FCS2 flow cell (Bioptechs, Butler, Pa.) using a 50 um thick gasket. The flow cell was placed on a movable stage that is part of a high-efficiency fluorescence imaging system built around a Nikon TE-2000 inverted microscope equipped with a total internal reflection (TIR) objective. The slide was then rinsed with HEPES buffer with 100 mM NaCl and equilibrated to a temperature of 50° C. An aliquot of the M13 template fragments described above was diluted in 3×SSC to a final concentration of 1.2 nM. A 100 ul aliquot was placed in the flow cell and incubated on the slide for 15 minutes. After incubation, the flow cell was rinsed with 1×SSC/HEPES/0.1% SDS followed by HEPES/NaCl. A passive vacuum apparatus was used to pull fluid across the flow cell. The resulting slide contained M13 template/olig(dT) primer duplex. The temperature of the flow cell was then reduced to 37° C. for sequencing and the objective was brought into contact with the flow cell.

For sequencing, cytosine triphosphate, guanidine triphosphate, adenine triphosphate, and uracil triphosphate, each having a cyanine-5 label (at the 7-deaza position for ATP and GTP and at the C5 position for CTP and UTP (PerkinElmer)) were stored separately in buffer containing 20 mM Tris-HCl, pH 8.8, 10 mM MgSO₄, 10 mM (NH₄)₂SO₄, 10 mM HCl, and 0.1% Triton X-100, and 100 U Klenow exo⁻ polymerase (NEN). Sequencing proceeded as follows.

First, initial imaging was used to determine the positions of duplex on the epoxide surface. The Cy3 label attached to the M13 templates was imaged by excitation using a laser tuned to 532 nm radiation (Verdi V-2 Laser, Coherent, Inc., Santa Clara, Calif.) in order to establish duplex position. For each slide only single fluorescent molecules that were imaged in this step were counted. Imaging of incorporated nucleotides as described below was accomplished by excitation of a cyanine-5 dye using a 635 nm radiation laser (Coherent). 5 uM Cy5CTP was placed into the flow cell and exposed to the slide for 2 minutes. After incubation, the slide was rinsed in 1×SSC/15 mM HEPES/0.1% SDS/pH 7.0 (“SSC/HEPES/SDS”) (15 times in 60 ul volumes each, followed by 150 mM HEPES/150 mM NaCl/pH 7.0 (“HEPES/NaCl”) (10 times at 60 ul volumes). An oxygen scavenger containing 30% acetonitrile and scavenger buffer (134 ul HEPES/NaCl, 24 ul 100 mM Trolox in MES, pH6.1, 10 ul DABCO in MES, pH6.1, 8 ul 2M glucose, 20 ul Nal (50 mM stock in water), and 4 ul glucose oxidase) was next added The slide was then imaged (500 frames) for 0.2 seconds using an Inova301K laser (Coherent) at 647 nm, followed by green imaging with a Verdi V-2 laser (Coherent) at 532 nm for 2 seconds to confirm duplex position. The positions having detectable fluorescence were recorded. After imaging, the flow cell was rinsed 5 times each with SSC/HEPES/SDS (60 ul) and HEPES/NaCl (60 ul). Next, the cyanine-5 label was cleaved off incorporated CTP by introduction into the flow cell of 50 mM TCEP for 5 minutes, after which the flow cell was rinsed 5 times each with SSC/HEPES/SDS (60 ul) and HEPES/NaCl (60 ul). The remaining nucleotide was capped with 50 mM iodoacetamide for 5 minutes followed by rinsing 5 times each with SSC/HEPES/SDS (60 ul) and HEPES/NaCl (60 ul). The scavenger was applied again in the manner described above, and the slide was again imaged to determine the effectiveness of the cleavelcap steps and to identify non-incorporated fluorescent objects.

The procedure described above was then conducted 100 nM Cy5dATP, followed by 100 nM Cy5dGTP, and finally 500 nM Cy5dUTP. The procedure (expose to nucleotide, polymerase, rinse, scavenger, image, rinse, cleave, rinse, cap, rinse, scavenger, final image) was repeated exactly as described for ATP, GTP, and UTP except that Cy5dUTP was incubated for 5 minutes instead of 2 minutes. Uridine was used instead of Thymidine due to the fact that the Cy5 label was incorporated at the position normally occupied by the methyl group in Thymidine triphosphate, thus turning the dTTP into dUTP. In all 64 cycles (C, A, G, U) were conducted as described in this and the preceding paragraph.

Once 64 cycles were completed, the image stack data (i.e., the single molecule sequences obtained from the various surface-bound duplex) were aligned to the M13 reference sequence. The image data obtained was compressed to collapse homopolymeric regions. Thus, the sequence “TCAAAGC” would be represented as “TCAGC” in the data tags used for alignment. Similarly, homopolymeric regions in the reference sequence were collapsed for alignment. The sequencing protocol described above resulted in an aligned M13 sequence with an accuracy of between 98.8% and 99.96% (depending on depth of coverage). The individual single molecule sequence read lengths obtained ranged from 2 to 33 consecutive nucleotides with about 12.6 consecutive nucleotides being the average length.

The alignment algorithm matched sequences obtained as described above with the actual M13 linear sequence. Placement of obtained sequence on M13 was based upon the best match between the obtained sequence and a portion of M13 of the same length, taking into consideration 0, 1, or 2 possible errors. All obtained 9-mers with 0 errors (meaning that they exactly matched a 9-mer in the M13 reference sequence) were first aligned with M13. Then 10-, 11-, and 12-mers with 0 or 1 error were aligned. Finally, all 13-mers or greater with 0, 1, or 2 errors were aligned. At a coverage depth of greater than or equal to one, 5,001 bases of the 5,066 base M13 collapsed genome were covered at an accuracy of 98.8%. Similarly, at a coverage depth of greater than or equal to five, 83.6% of the genome was covered at an accuracy of 99.3%, and at a depth of greater than or equal to ten, 51.9% of the genome was covered at an accuracy of 99.96%. The average coverage depth was 12.6 nucleotides.

The foregoing description has been limited to a few specific embodiments of the invention. It will be apparent however, that variations and modifications can be made to the invention, with the attainment of some or all of the advantages of the invention. It is therefore the intent of the inventor to be limited only by the scope of the appended claims.

1. An apparatus for single molecule analysis of a sample, the apparatus comprising:
at least two lasers that produce light at distinct wavelengths;
a collimator for directing said light onto a sample attached to a solid support through a total internal reflection objective, said sample producing a first fluorescent emission in response to one of said distinct wavelengths of light to identify the location of a single nucleic acid molecule in said sample and a second fluorescent emission in response to the other one of said distinct wavelengths of light to detect incorporation of a fluorescently labeled nucleotide into said single nucleic acid molecules; and at least one detector for detecting said fluorescent emissions.

2. The apparatus of claim 1, further compromising a focusing laser for maintaining focus of said objective on said sample.

3. The apparatus of claim 2, wherein said focusing laser is an infrared laser.

4. The apparatus of claim 1, wherein said collimator comprises a band-pass filter, a diverging lens in optical communication with said band-pass filter, a collimating lens in optical communication with said diverging lens, a field stop in optical communication with said collimating lens, and a converging lens in optical communication with said field stop.

5. The apparatus of claim 17, wherein said receiver comprises a tube lens and a band-pass filter in optical communication with said tube lens.

6. The apparatus of claim 1, wherein said at least one detector is a camera.

7. The apparatus of claim 1, wherein said at least two leasers comprise a first laser turned to a wavelength of about 532 nm and a second laser turned to a wavelength of about 647 nm.

8. The apparatus of claim 1, wherein said collimator comprises a converging lens in optical communication with a field stop, said field stop in optical communication with a collimating lens.

9. The apparatus of claim 22, wherein said support is a stage upon which is located a flow cell.

10. The apparatus of claim 9, wherein said flow cell comprises an inlet port and an outlet port for exposing of said sample to reagents.

11. The apparatus of claim 10, wherein said flow cell further comprises a slide on which said sample is placed.

12. The apparatus of claim 1, wherein said sample comprises nucleic acid duplex.

13. The apparatus of claim 12, wherein at least a portion of said nucleic acid duplex is optically resolvable in isolation from other nucleic acid duplexes of said sample.

14. The apparatus of claim 1, wherein said single molecule is a nucleic acid duplex comprising a template and a primer of template-dependent synthesis hybridized thereto.

15. The apparatus of claim 14, wherein said second fluorescent emission is produced by a label attached to said nucleotide, wherein said nucleotide is incorporated into said duplex as a result of template-depending sequencing by synthesis.

16. The apparatus of claim 6, wherein said at least one camera is in communication with a computer for storage and analysis of images produced by said fluorescent emissions.

17. The apparatus of claim 1, further compromising a receiver for receiving fluorescent emissions produced by a single molecule in said sample in response to said light at distinct wavelengths.

18. An apparatus for single molecule analysis of a sample, the apparatus comprising:
a support having said sample attached thereon; at least two lasers that produce light at distinct wavelengths; a collimator for directing said light onto said sample through a total internal reflection objective, said sample producing a first fluorescent emission in response to one of said distinct wavelengths of light; and at least one detector for detecting said first fluorescent emission.

19. The apparatus of claim 18, wherein one wavelength is infrared.

20. The apparatus of claim 19, wherein infrared is used for auto-focus.

21. The apparatus of claim 18, wherein one wavelength is fluorescent.

22. The apparatus of claim 1, wherein the apparatus further comprises a support having said sample located thereon.

23. The apparatus of claim 1, wherein said first and second fluorescent emissions are produced sequentially.
